(19) United States
(12) Patent Application Publication
(10) Pub. No.: US 2012/0156493 A1
(43) Pub. Date: Jun. 21, 2012

(54) NANOSTRUCTURED SI-C-COMPOSITE FOR ELECTRODE APPLICATIONS

(75) Inventors: Arkadi Maisels, Hanau (DE); Yves Gorat Stommel, Shanghai (CN); Frank Stenger, Alzenau (DE); Martin Miessen, Marl (DE); Jutta Zimmermann, Alzenau (DE); Manfred Dannehl, Kahl am Main (DE); Peter Pilgram, Ingolstadt (DE)

(73) Assignee: Evonik Degussa GmbH, Essen (DE)

(21) Appl. No.: 13/384,417

(22) PCT Filed: May 18, 2010
(86) PCT No.: PCT/EP2010/056780

§ 371 Date: Feb. 29, 2012

(30) Foreign Application Priority Data
Jul. 17, 2009 (DE) 10 2009 033 739.3

(51) Int. Cl. B32B 5/16; H01B 1/04; B82Y 30/00

(52) U.S. Cl. 428/402; 252/502; 977/775; 977/948; 977/896

(57) ABSTRACT

The invention relates to a process for producing nanostructured silicon-carbon composites, comprising the (A) introduction of at least one of components (a1) mono- and/or polyhydroxyaromatic compound, and (a2) an aldehyde, and (a3) a catalyst, into a reactor to obtain a composition in which the components react with one another in the presence of the catalyst at a reaction temperature T of 75 to 200° C., and at a pressure of 80 to 2400 kPa, and over a period to of 0.001 to 1 000 000 s, which gives a preliminary gel, and (B) introduction of at least one component (b1) sub-micron silicon powder, in crystalline or amorphous form, into the composition obtained during or after step (A), and then (C) introduction of the product obtained after step (B) into a neutralizing agent selected from an acid if (a3) is a basic catalyst, or an alkali if (a3) is an acidic catalyst, which gives a finely divided product, and (D) drying the product obtained during or after step (C) and then (E) carbonizing the product obtained after step (D) at a temperature of 500 to 1200° C., to the composites themselves, to the use thereof as an anode material for lithium ion cells and batteries, and to the lithium ion cells and batteries.

The invention relates to a process for producing nanostructured silicon-carbon composites, to the composites themselves and to the use thereof as anode material for lithium ion batteries.

In commercial lithium ion batteries, principally graphites are currently being used as anode material. In the case of full exploitation of the intercalation sites of graphite (LiC₆), a theoretical capacity of 372 mAh/g is thus available, but the practically usable reversible capacity is lower. Such an anode combined with a lithium-transition metal-based cathode gives energy densities of 150-200 Wh/kg or 410-500 Wh/l.

One way of satisfying the demand for rising energy densities is to replace graphite with other substances which can likewise be intercalated by Li ions. Of particular interest here are the intermetallic phases of lithium with tin or silicon. Maximum theoretical specific capacities are ˜990 mAh/g for Li₂₂Sn₅, and ˜4200 mAh/g for Li₂₂Si₅. Particularly the large volume expansions in the course of lithium intercalation/discharge result in abysmal cycling performance of these intermetallic anodes.

At present, the person skilled in the art is thus left merely with the option of choosing between graphites with a relatively low specific capacity but quite high cycling stability, and newer materials with cycling stability which is still completely unsatisfactory.

A comprehensive overview of causes and the variety of different approaches for overcoming the difficulties in the case of use of silicon as an active component in lithium ion batteries has been given by Kasavajjula, Wang and Appleby in Journal of Power Sources 163 (2007), 1003-1039.

A significant cause mentioned here is the high change in volume of ˜400% between pure silicon and fully lithiated Li₂₂Si₅, and the resulting poor electronic contact between silicon particles and the conductivity additives used.

The prior art is aware of the following approaches to a solution for overcoming the problems resulting from the expansion in volume:
1. anodes of pure silicon in powder form on the micro- and nanometer scale;
2. Si dispersed in an inactive matrix;
3. Si dispersed in an active matrix;
4. silicon anodes with various binders
5. thin films of Si.

Re1.: The reduction in the silicon particles used in the sub-micrometer range reduces the absolute difference in volume of the particles in the course of lithiation and delithiation, but the electronic contact between the particles and the output conductor is lost, as reported by Guo, Wang, Liu, Dou in J. Power Sources 146 (2005) 448.

Re2.: High-energy mixing of silicon or else tin with electronically conductive additives such as nitrides, borides of transition metals and silicides of transition metals and B and Ca, but also metallic additions such as Fe, Co, Ni, Cu, have unacceptable irreversible capacities which can be reduced only by addition of graphite or carbon-based coating. A lithium ion battery with a tin-cobalt-carbon-based anode having a capacity higher by ˜30% is disclosed in a patent EP 1 643 572 A 1 to Sony.

Re3.: Active matrices may consist of metals, but also of carbon. For example, Mg₂Si is intercalated by Li in 3 stages, the large expansion in volume leading to the destruction of the anode, as reported by Kim et al. in J. Electrochem. Soc. 146 (1999) 4401. Dahn et al. report, in J. Electrochem. Soc. 150 (2003) A149, a high reversible capacity in the case of Si₂Sn, but there are no statements about cycling data.

Alloys of silicon with the active metals Sn, Zn, Al, or with inactive metals such as Cu, Co, Ni, B, Ti, Sb, are disclosed in EP 1 463 131 A1 to Canon Kabushiki Kaisha. These alloys exhibit capacities above 1000 mAh/g for 30 cycles. An Si—Sn—Ni alloy still exhibited 75% of the starting capacity in a full cell with LiCoO₂ cathode at 100 cycles, as disclosed in U.S. 2004/0248011 to Canon Kabushiki Kaisha.

Active carbon matrices can be produced by various techniques:

### PYROLYSIS/CVD/TVD PROCESSES

The pyrolysis of various polysiloxanes, for example polymethylphenylsiloxane (PMPS) and polyphenylsesquisiloxanes (PPSSO), leads at temperatures above 1300° C. to inactive silicon carbide, and at about 1000° C., for example, to C_{2.9}SiOH_{y} where y=0−1. This material is amorphous and exhibits an irreversible loss of about 300 mAh/g with a reversible capacity of 450 mAh/g, as disclosed in Dahn et al. in Solid State Ionics 74 (1994) 249.

Similar results were found by pyrolysis of other Si-containing polymers by Dahn et al., J. Mat. Sci. Lett 19 (2000) 53, and by co-pyrolysis of polymethacrylonitriles/divinylbenzenes with tetramethylsilane or tetravinylsilane by Hayes et al., J. Electrochem. Soc. 146 (1999) 2435, and were attributed to the remaining oxygen content.

TVD deposition of silicon on carbon as tetrahydrosilane on graphites, for example MCMB, gave a rise in capacity from 290 mAh/g to 462 mAh/g, with a coulombic efficiency of only 45%. SEI formation, irreversible Li binding and loss of active material are assumed to be significant reasons by Xie in Mater. Chem. Phys. 88 (2003) 295.

If Timcal KS-6 is used as a substrate for the silicon deposition, the irreversible capacity is only 26%. The reasons stated for this are similar to those stated by Xie. The better cycling performance is explained by the binding top layer of Li₂O, which has been formed by reaction of the lithium with the surface oxygen of the silicon deposited, as reported by Holzapfel et al. in Chem. Commun. (2005), 1566.

Deposition of carbon by gas phase deposition on silicon exhibits relatively low irreversible capacities, but the carbon shell gradually yields to the pressure of the expanding silicon, and the capacity declines rapidly: Dimov et al., J. Power Sources 114 (2003) 88.

Even in the case of limited charge capacity, such a decline occurs in less than 100 cycles. Liu et al. explain this in an article in J. Electrochem. Soc. 152 (2005) A1719 by the fact that charge and discharge capacity are virtually the same at first, but, as soon as the carbon shell weakens, the particles at first lose electronic contact in the course of discharge and the discharge capacity falls, and the contact of the particles in the course of charging collapses at a later stage.

Silicon-carbon composite materials can also be obtained purely by mechanical means, by energy input into the ball mill. Wang et al. show, in J. Electrochemical Soc. 145 (1998), 2751, that intensive grinding increases the reversible capacity compared to the components which have merely been mixed, the irreversible capacity increasing with the silicon content.

According to Liu et al., Solid State Ionics 168 (2004), 61, and Electrochem. Solid State Lett. 7 (2004), A369, the combination of ball mill and pyrolysis improves both the cycling performance and the reversible capacity. Silicon and carbon precursor were first mixed by grinding, the mixture was pyrolyzed and the resulting coarse pore structure was then destroyed again by grinding. Adding carbon precursors again with subsequent pyrolysis raised the coulombic efficiency to 80%.

Another way of producing Si-carbon composite materials is to use carbon gels as precursor material for a pyrolysis.

In a first variant, according to Niu et al., Anal. Commun. 36 (1999), 81, graphite in platelet form is suspended in methyltrimethoxysilane and the suspension is gelated at RT to give a sol-gel graphite (SGG). The powder resulting therefrom has an open 3-dimensional network with percolating graphite particles. Grinding of SGG powder with silicon powder and processing of this mixture to give electrodes results in anodes with 80% coulombic efficiency and 12% fading over 25 cycles.

A further variant is, according to Wang et al., the addition of nanocrystalline Si powder to a gelating resorcinol-formaldehyde mixture which cures at 85° C. for 10 hours, as disclosed in Electrochem. Commun. 6 (2004), 689. This mixture is a compact block which is converted at 650° C. to a silicon-carbon composite material with 40% carbon. There are no details in the article of the further sample preparation and electrode composition or production, but the resulting composite is provided with PVDF in NMP as a binder, coated onto aluminum foil, processed to give a half-cell with Li metal, and electrochemically characterized with C/10 between 0.02-2.0 V. In spite of the assumed silicon content in the composite material of 60%, the irreversible loss in the 1st cycle is below 25%.

Even though only a portion of the silicon introduced is apparently involved in the cycling, a good stability is stated over 50 cycles. In a half-cell with lithium, the use of aluminum foil as a current collector is possible, but would require a novel current collector on the cathode side in a full cell. There are no reports of intercalation of the aluminum current collector by lithium.

Re4.: The replacement of thermoplastic PVDF with elastomers such as polyisobutene in Holzapfel et al., Electrochem. Solid State Lett. 8 (2005), A516, or EPDM in Ishihara et al., J. Power Sources 146 (2005), 161, likewise resulted in high irreversible losses or in severe fading. Even the replacement of soluble elastomers with aqueous emulsions, for example of styrene-butadiene rubber (SBR) with sodium carboxymethylcellulose (NaCMC) as a viscosity modifier, as reported by Liu et al. in Electrochem. Solid State Lett. 8 (2005), A100, was successful only for nearly 50 cycles with a limitation of the capacity to 600 mAh/g.

Re5.: The consideration of minimizing the absolute expansion in volume of the silicon in the course of cycling results in attempts to produce binder-free nanocrystalline or amorphous layers on a current collector. Various authors, for example Dahn et. al. in J. Electrochem. Soc. 151 (2004) A838, characterize the crystalline and amorphous phases which occur in the course of cycling. Accordingly, in the course of lithiation, the voltage should not go below 0.05 V in order to avoid the coexistence of a mechanical stress-inducing crystalline phase Li₁₅Si₄ as well as the lithiated amorphous phase. The influence of the thickness of the Si layer, as reported in Yoshimura in J. Power Sources 146 (2005) 445, and of the deposition rate, Ohara in J. Power Sources 119 (2005) 591, has also been studied without any positive influence on the cycling stability.

A common factor to all these technical teachings is the disadvantage of the known composite materials for use as an anode material in a lithium ion battery, in the form of their high irreversible capacities and their cycle numbers in charging and discharging operations, which are too low for practical applications.

It was therefore an object of the present invention to provide a process for producing silicon-carbon composites and the silicon-carbon composite itself, which is suitable for use as an anode material with sufficient capacity and cycling stability in a lithium ion battery.

The present invention provides a process for producing a nanostructured silicon-carbon composite, which comprises the steps of:
(A) introducing at least the components
   (a1) mono- and/or polyhydroxyaromatic compound, and
   (a2) an aldehyde, and
   (a3) a catalyst,
into a reactor to obtain a composition in which the components react with one another in the presence of the catalyst
   at a reaction temperature T of 75 to 200° C., and
   at a pressure of 80 to 2400 kPa, and
   over a duration t_{A} of 0.001 to 1 000 000 s to obtain a pregel, and
(B) introducing at least one component
   (b1) sub-micron silicon powder, crystalline or amorphous, into the composition obtained during or after step (A), and then
(C) introducing the product obtained after step (B) into a neutralizing agent,
   selected from an acid if (a3) is a basic catalyst, or
   an alkali if (a3) is an acidic catalyst to obtain a fine product, and
(D) drying the product obtained during or after step (C), and then
(E) carbonizing the product obtained after step (D) at a temperature of 500 to 1200° C.

The process claimed has the advantage that the process can equally be performed continuously or batchwise.

The process according to the invention makes it possible to obtain homogeneous distributions of defined amounts of silicon particles in the silicon-carbon composite. Such distributions enable homogeneously high capacities of anode materials produced therefrom for energy storage systems, for example lithium ion batteries.

The process according to the invention has the further advantage that a product thus obtained has an improved particulate fineness for further processing to the electrode material, which makes the mechanical processing known to the person skilled in the art superfluous. The mechanical processing to give the electrode material harbors the risk, which is well-known in the prior art, of cracking and of destruction of the structure of the composite.

The present invention therefore likewise provides a nanostructured silicon-carbon composite which has a mean particle size of <40 μm, a mesopore volume of 0.005 to 3 cm³/g, a carbon content of 20 to 99% by weight, and a proportion of the inorganic phase of 1 to 80% by weight.

The inventive silicon-carbon composite has the following advantages:
The composite has a very good silicon particle distribution in the carbon matrix.
The carbon matrix of the inventive composite has a pore structure matched optimally to the silicon particle morphology. The matched pore structure enables the changes in volume which occur in the charging/discharging operation, synonymous to the lithiation/delithiation, to be compensated for ideally without any mechanical stress on the carbon matrix.
The mechanical stresses which arise as a result of the expansion or contraction in volume in the course of lithiation or delithiation are dissipated in the carbon matrix in the pores.
The inventive composite has very good electrical contacting of the silicon particles to the carbon matrix, as a result of which a high cycling stability is achieved in the case of use as anode material. This ensures a high reversible capacity.

A further advantage of the inventive silicon-carbon composites is that it can be used either with or without further treatment steps for production of anode slurries. Such anode slurries may be solvent- or water-based, and can be produced by means of methods known to those skilled in the art.

When the inventive composite is used in energy storage systems, for example in batteries or cells which have significantly higher capacities, except in the case of graphite electrodes, batteries or cells having a higher cycling stability are obtained.

Even though significant changes in volume in the crystalline and/or amorphous phases of the ion-intercalating particles occur in the course of cycling or in the charging/discharging operation, the binding of these particles within the carbon matrix is maintained in the inventive composite. Thus, electronic contact is preserved in the inventive composite.

The superiority of the binding of the silicon or of the ion-intercalating substance into the carbon matrix over the prior art thus achieves high utilization of the silicon introduced, or of the substance, and ensures the available capacity of the energy store in a lasting manner.

The present invention therefore likewise provides for the use of the inventive nanostructured silicon-carbon composite as anode material in energy storage systems, and the use of the silicon-carbon composite obtained by the process claimed in energy storage systems.

The present invention likewise provides a lithium ion cell which comprises the inventive nanostructured silicon-carbon composite.

The invention further provides a lithium ion cell which comprises the silicon-carbon composite produced by the process according to the invention.

The present invention likewise provides a lithium ion battery which comprises the inventive nanostructured silicon-carbon composite.

The present invention further provides a lithium ion battery which comprises the silicon-carbon composite produced by the process according to the invention.

The invention is illustrated in detail hereinafter.

It may be advantageous, in step (A) of the process according to the invention, to select component (a1) from monohydroxybenzene, dihydroxybenzenes, for example resorcinol, hydroquinone, and/or catechol, or to select it from trihydroxybenzenes, for example phloroglucinol, or a mixture of these compounds.

More preferably, (a1) may be selected from catechol, resorcinol, phloroglucinol, hydroquinone, phenol or a mixture of these compounds. Most preferably, it is possible to use phenol. The latter is notable for a high carbon content and low reactant costs.

Component (a2) may be selected from formaldehyde, glyoxal, glutaraldehyde, furfural, or a mixture of these aldehydes. More preferably, formaldehyde may be used. It may also be advantageous to use the aldehydes used in the form of an aqueous solution or in a solvent. The solvent may be selected from water, alcohols, ketones, or a mixture of these solvents. Additionally preferably, (a2) may be a solution of formaldehyde, water and stabilizers, for example methanol.

In step (A) of the process according to the invention, it is advantageously possible to use precondensates based on mono- and/or polyhydroxybenzene and aldehyde, for example resols and novolac.

When mono- and/or polyhydroxybenzene or aldehyde is used as (a1) or (a2), the concentration of mono- and/or polyhydroxybenzene and aldehyde in the reaction mixture may be from 10 to 60% by weight, preferably from 20 to 40% by weight, more preferably from 20 to 30% by weight.

Additionally preferably, the molar ratio of mono- and/or polyhydroxybenzene to aldehyde, if these components are used, may be from 1:1 to 1:4, more preferably from 1:2 to 1:3.

The catalyst used in step (A) is selected from acid and base. It may be preferable to use a base.

The acid as component (a3) of the process according to the invention may be selected from organic and inorganic acids, each with a sufficient solubility. Sufficient solubility is synonymous with the fact that the selection of the solvent and the amount thereof allows the pH in the course of performance of step (A) to be adjusted. The acid may more preferably be selected from HCl, formic acid, acetic acid.

A basic component (a3) may, for example, be an alkali metal or alkaline earth metal hydroxide with a sufficient solubility in the solvent. Sufficient solubility is synonymous with the fact that the selection of the solvent and the amount thereof allows the pH to be adjusted in the course of performance of step (A). Preferably, (a3) may be selected from NaOH, KOH, Na₂CO₃, K₂CO₃, NH₃. More preferably, NaOH may be used.

When mono- and/or polyhydroxybenzene or aldehyde is used as (a1) or (a2), and NaOH is used as component (a3), the molar ratio of the mono- and/or polyhydroxybenzene used to NaOH may be preferably from 0.1 to 100, more preferably from 0.5 to 50, most preferably from 0.7 to 20. The selection of the molar ratio from these ranges has the advantage that a homogeneously gelated pregel is obtained and, after the performance of the process according to the invention, a defined pore structure is obtainable.

In step (A) of the invention, a further component (a4), pore former, can be used. The pore former may be selected from ethylene glycol, polyethylene glycol, butylene glycol, diethylene glycol, triethylene glycol, gamma-butyrolactone, propylene carbonate, dimethylformamide, monoethanolamine or N-methyl-2-pyrrolidinone, or a mixture of these substances.

If component (a3) is selected from a base, it may be advantageous to select the pH of the composition in step (A) of the process according to the invention from 7.5 to 13, preferably from 8.5 to 12.0, more preferably from 9.0 to 9.7.

It may be advantageous to mix components (a1)-(a3) in a separate vessel in step (A) before they are introduced into the reactor. The mixing can be effected at a different temperature than the reaction temperature T. This additionally allows the reaction kinetics to be influenced.

The reaction temperature T may preferably be from 80 to 150° C., more preferably from 85 to 140° C. The pressure used during step (A) in the reactor may preferably be selected from 100 to 700 kPa, more preferably from 125 to 500 kPa.

The pressure used in step (A) can be applied from the outside, by increasing the temperature in the closed system, or by a combination of the two.

The duration t_{A} is measured in step (A) from the time from which the reaction temperature T has been attained. t_{A} may preferably be from 1 to 36 000 s, more preferably from 60 to 3600 s.

The conversion in step (A) can be effected with stirring.

Step (B) of the process according to the invention can preferably be performed while the components are being converted in the reactor in the performance of step (A). The time of introduction of component (b1) into the composition obtained during or after step (A) can be fixed by determining the light transmission. The light transmission value at the time of introduction of (b1) at a wavelength of 475 nm may be less than 80%, preferably between 0.01% and 70% and more preferably between 0.1% and 50% of the starting transmission. The starting transmission is measured at the time when components (a1)-(a3) have been introduced into the reactor.

The light transmission can be measured in situ with the E616 photometer (from Metrohm).

The time of introduction of component (b1) into the composition obtained during or after step (A) can be fixed by measuring the conductivity of the mixture.

Additionally preferably, the performance of steps (B) and (A) can be commenced at the same time.

Additionally preferably, the pregel which is obtained in step (A) can be cooled before the performance of step (B) over a duration t_{B} of 0.001 to 3600 s, preferably over 1 to 3600 s. More preferably, the pregel can be cooled abruptly before the performance of step (B). The temperature of the cooled pregel before the performance of step (B) may be selected from 25 to 95° C., preferably from 30 to 80° C., more preferably from 35 to 70° C.

In the context of the present invention, the term “sub-micron” is understood to mean the length or size range from 1 nm to 999 nm. For example, sub-micron powder is synonymous with powder whose particle sizes are within the range from 1 nm to 999 nm. Component (b1), which is referred to as inorganic phase in the context of the present invention, comprises or is sub-micron silicon powder, in crystalline or amorphous form. Most preferably, the inorganic phase is sub-micron crystalline or sub-micron amorphous silicon powder.

It may be advantageous, in step (B) of the process according to the invention, to introduce component (b1) in an amount of 1 to 80% by weight, preferably from 3 to 60% by weight, more preferably from 5 to 20% by weight and most preferably from 10 to 40% by weight, the amount being based on the mass of the composite obtained after step (E).

It may be advantageous when component (b1) introduced in step (B) of the process according to the invention, apart from silicon, comprises at least one further component, which is referred to as second inorganic phase in the context of the present invention.

The second inorganic phase may preferably be in sub-micron particulate form and/or be a sub-micron composite. More preferably, this inorganic phase may comprise or be inorganic particles, which may additionally more preferably be in crystalline, amorphous and/or surface-modified form. Most preferably, the second inorganic phase may comprise or be surface-modified particles. The surface modification improves the dispersion and/or the conductivity of the inventive composite or that obtained in accordance with the invention.

The silicon particles may also be surface-modified.

The inorganic particles and/or silicon particles may comprise or consist of agglomerated primary particles. The mean primary particle size may be from 5 to 200 nm, preferably from 10 to 150 nm, more preferably from 30 to 100 nm.

The primary particle size can be determined by means of TEM, SEM or REM, which are known to those skilled in the art.

It may additionally be advantageous to select the second inorganic phase from metal element and/or ion, preferably lithium, tin, aluminum, magnesium, calcium, copper, zinc, cobalt, nickel, manganese, titanium, antimony, or mixtures of these metal elements and/or ions, and/or selected from compounds of the aforementioned substances with boron and/or nitrogen, phosphorus, oxygen and/or nonmetallic substances, for example carbon black, carbon aerogels, carbon nanotubes, carbon nanorods, graphite, graphenes, graphitic structures or mixtures of the aforementioned substances.

Preferably, the second inorganic phase can be introduced during and/or after the introduction of the sub-micron crystalline and/or amorphous silicon powder, more preferably during the introduction of this silicon powder.

It may also be advantageous to disperse component (b1) in a dispersant before performance of step (B). The dispersants used may, for example, be water, alcohols or mixtures thereof.

Component (b1) can be introduced into the pregel during step (B) by means of stirrer units, rotor-stator systems, high-pressure homogenizers or ultrasound.

It may be advantageous, in step (C) of the process according to the invention, to introduce the product obtained after step (B) by means of spraying or with vigorous stirring.

The fineness of the product obtained in step (C) can be determined by means of laser diffraction analysis technology.

More preferably, step (C) of the process according to the invention can be performed after a duration t_{C} which is the duration between the commencement of introduction of component (bl) and the commencement of performance of step (C).

The duration t_{C} may preferably be selected from 0.01 to 3600 s, more preferably from 0.1 to 1800 s, most preferably from 1 to 900 s.

If the neutralizing agent is an acid, it can be used in the form of a solution, vapor, or in the form of a gas. This acid can preferably be used in concentrated or dilute form.

If an acid is used in step (C), it may be inorganic, for example mineral, or an organic acid. The mineral acid may be selected from hydrochloric acid, nitric acid, phosphoric acid and sulfuric acid. The organic acid may be selected from acetic acid, formic acid and oxalic acid. The vaporous or gaseous acid used may more preferably be HCl.

When a gaseous acid is used in step (C), it is preferably brought to a temperature of 10 to 300° C., further preferably from 50 to 200° C., more preferably from 70 to 180° C.

The acid used may have a pH of less than 2.0, preferably from 0.5 to 1.5, more preferably from 0.5 to 1.0.

If the neutralizing agent used in step (C) is a base, it is used in the form of a solution. The neutralizing agent used in step (C) can preferably be used in concentrated or dilute form.

When a base is used in step (C), it is possible to use, for example, an alkali metal or alkaline earth metal hydroxide with a sufficient solubility in the solvent. The base may preferably be selected from NaOH, KOH, Na₂CO₃, K₂CO₃, NH₃ and any other base. More preferably, NaOH may be used.

The base used may have a pH of greater than 9.0, preferably from 9.5 to 14, more preferably from 9.5 to 13.

The volume of neutralizing agent used may be at least 1 time, preferably at least 4 times, the product obtained after step (B).

The neutralizing agent may preferably have a temperature of 0 to 200° C., more preferably from 10 to 90° C., most preferably from 15 to 50° C.

The neutralizing agent can preferably be stirred during step (C).

When the product obtained after step (B) is sprayed in step (C), the spraying can be effected by means of nozzles. The nozzle orifices may preferably be from 0.01 to 8 mm, more preferably from 0.05 to 5 mm and most preferably from 0.1 to 3 mm in size.

The nozzles used may be single- or multisubstance nozzles. The nozzles used may likewise advantageously be full-cone, hollow-cone, flat-jet and smooth-jet nozzles. Additionally preferably, it is possible in step (C) to use rotary atomizers, vibratory atomizers or Venturi nozzles.

The droplet size generated by the spraying in process step (C) may be from 50 nm to 3 mm, preferably from 100 nm to 1 mm, more preferably from 200 nm to 0.5 mm.

It may also be advantageous to perform step (C) by mixing (bl) directly with the pregel from step (A) by means of a multisubstance nozzle, and introducing it directly into the neutralizing agent.

When the product obtained from (B) is introduced by spraying during step (C), the atomizer medium selected may be a gaseous substance, preferably air, nitrogen, CO₂, argon and/or vaporous or gaseous acids, among these preferably HCl.

The spraying during the performance of step (C) into the neutralizing agent can be supported by external fields, which may preferably be electrical or acoustic fields, for example ultrasound.

After introduction of the product obtained after step (B) into a neutralizing agent in step (C), additional shear energy can be introduced into the system during this step in order to obtain a fine product.

The shear energy can be introduced by means of stirrer units, rotor-stator systems, ultrasound or high-pressure homogenizers.

The residence time in the neutralizing agent during step (C) may be selected from 0.01 to 100 000 s, preferably from 1 to 10 000 s, more preferably from 10 to 5000 s.

The product obtained during or after step (C) can be thickened, purified and/or dried.

The product obtained during or after step (C) can likewise preferably be purified by repeated washing by means of distilled water during the thickening in order to advantageously remove ionic constituents.

The thickening of the product obtained during or after step (C) can be effected by means of centrifugation, sedimentation or filtration, or thermally.

The product obtained during or after step (C) can likewise preferably be effected by repeated washing by means of distilled water, if it is thickened by filtration.

Also advantageously, the product obtained during or after step (C) can be purified by means of electrodialysis.

The drying in step (D) can preferably be effected convectively, supercritically, by means of freeze-drying, infrared radiation or microwave radiation, or as a combination of the aforementioned drying methods.

If gaseous acid is used in step (C), step (D) can be performed during process step (C).

It may be advantageous, in step (D) of the process according to the invention, to perform convective drying or freeze-drying. In the case of convective drying, the temperature selected may preferably be from 10 to 300° C., more preferably from 50 to 200° C. If freeze-drying is performed, the temperature selected may be from minus 50 to 0° C., more preferably from minus 20 to 0° C.

The convective drying can particularly advantageously be performed in the form of spray drying. The use of spray drying advantageously affords a fine product as a result of the individualized drying of the particles.

If spray-drying is performed in step (D), the product obtained during or after step (C) can advantageously also be dried without thickening. The spray drying can preferably be performed at a temperature of 80 to 300° C., more preferably from 80 to 250° C.

The product obtained after performance of step (D) may have a residual moisture content.

The residual moisture content may, based on the proportion by mass of the solvent in the reaction mixture from step (A), be from 0 to 90% by weight, preferably from 10 to 80% by weight, more preferably from 65 to 75% by weight.

The proportion by mass of the residual moisture is determined by gravimetry.

It may be advantageous to comminute the product obtained after step (D) before step (E). A further drying step may follow. Advantageously, the comminution makes ultrasmall pores accessible, which can subsequently be dried fully.

It may be advantageous, in step (E) of the process according to the invention, to perform the carbonization at a temperature of 600 to 900° C., more preferably from 650 to 800° C. Additionally preferably, the carbonization can be performed under exclusion of oxygen, preferably under protective gas, more preferably nitrogen or argon, further preferably under reduced pressure. It may also be advantageous to perform the carbonization by means of injection of infrared light, microwaves, under a plasma, or by means of electrical or thermal heating.

The silicon-carbon composite obtained after step (E) can be granulated if the inventive composite has particles whose mean size is less than 10 μm. The advantage of this aftertreatment is that evolution of dusts, which is troublesome in the further handling of the composite, is avoided.

In addition, the inventive silicon-carbon composite or that obtained in accordance with the invention can be aftertreated in any manner known to those skilled in the art.

The process according to the invention can be used to obtain nanostructured silicon-carbon composites.

The inorganic phase(s) within the particles of the inventive composite is/are preferably distributed within and/or on the surface of the particles.

The present invention also provides a nanostructured silicon-carbon composite, which is characterized in that the composite has a mean particle size of <40 μm, a mesopore volume of 0.005 to 3 cm³/g, a carbon content of 20 to 99% by weight and a proportion of the inorganic phase of 1 to 80% by weight.

The inventive composite may preferably have a mean particle size of 1 to 25 μm, more preferably of 5 and 20 μm.

The mean particle size is determined by means of laser diffraction to DIN ISO 13320-1 (1999). To evaluate the diffraction spectrum measured, the Fraunhofer theory is employed. The laser diffraction analysis instrument used is a HORIBA LA-920.

For analysis, the silicon-carbon composite is first introduced at room temperature with the aid of a magnetic stirrer into distilled water which has been adjusted to a pH of 9-10 with 0.1 M NaOH. The solids concentration is 1% by weight. The dispersion is effected in a water-cooled 30 ml snap-lid bottle by means of an ultrasound finger (from Bandelin, 70 W, pulsation 80) for 4.5 minutes. In a further step, the dispersed suspension is introduced dropwise into the dispersing liquid present in the wet cell in the analysis instrument (distilled water adjusted to pH=9-10 with 0.1 M NaOH) until laser shadowing between 5 and 10% is achieved. The suspension now present in the analysis instrument is pumped in circulation into the test cell by means of the stirrer incorporated in the analysis instrument.

The diffraction spectrum is assessed according to the Fraunhofer theory. The particle size distribution is represented as the numerical distribution Q₀ by conversion from the corresponding volume distribution. The mean particle size refers here, according to ISO 13320-1, to the x₅₀ of the Q₀ distribution.

Additionally preferably, the inventive composite may have a carbon content of 40 to 97% by weight, more preferably from 50 to 95% by weight and most preferably from 60 to 90% by weight.

The proportion of the silicon or of the silicon and of the further inorganic phase in the inventive silicon-carbon composite is, based on the weight of the composite, preferably from 3 to 60% by weight, more preferably from 5 to 50% by weight and most preferably from 10 to 40% by weight.

The further inorganic phase may be in sub-micron particulate form, or be a sub-micron composite.

The inventive composite may preferably have a mesopore volume of 0.01 to 3 cm³/g, preferably of 0.05 to 3 cm³/g and more preferably of 0.1 to 2 cm³/g.

It may be advantageous when the inventive silicon-carbon composite has a mean mesopore diameter of 1.8 to 50 nm, preferably of 5 to 45 nm and more preferably of 10 to 35 nm.

The mesopore volume and the pore radius distribution are determined to DIN 66134 (1998) by the BJH method from the desorption data of the isotherms recorded in the relative pressure range p/p0 of 0.99 to 0.34.

In addition, the inventive silicon-carbon composite may have a micropore volume of 0.01-1.0 cm³/g, preferably of 0.05-0.5 cm³/g, more preferably of 0.1-0.35 cm³/g. The micropore volume is determined to DIN 66135-1, 66135-2, 66135-3 (2001) by the t-plot method. The t-plot is assessed by the equation of de Boer.

It may be advantageous when the inventive silicon-carbon composite has a mean fractal dimension of 1.0 to 2.7, preferably of 1.1 to 2.5 and more preferably of 1.2 to 2.3.

The mean fractal dimension of the silicon-carbon composite is determined by means of image analysis of transmission electron microscope images according to Rogak et al, described in Aerosol Science and Technology, Vol. 18, 1993, pages 25-47.

The inventive silicon-carbon composite may be a foam.

The inventive silicon-carbon composite may have an STSA value of 20-1300 m²/g, preferably of 30-1000 m²/g and more preferably of 50-800 m²/g.

The STSA analysis is effected to DIN ISO 9277 (1995).

The inventive silicon-carbon composite may have a BET value of 20-1500 m²/g, preferably of 100-1200 m²/g and more preferably of 400-900 m²/g. The BET surface area is determined to DIN ISO 9277 (1995) in a NOVA e2000 sorption analysis instrument from QUANTACHROME. The sorption gas used is nitrogen. The samples are baked out before the determination at a temperature of 350° C. and a pressure of <13.3 Pa for more than 12 hours. The sorption isotherms are assessed to determine the BET surface area within the relative pressure range p/p₀ of 0.01 to 0.1.

The inventive silicon-carbon composite may have a content of volatile constituents of <15.0% by weight, preferably of <5.0% by weight, more preferably of <1.5% by weight and most preferably of <0.5% by weight.

The constituents which are volatile at temperatures of at least 950° C. are determined based on DIN 53552 (1977). For this purpose, the sample is first dried to constant weight at 105° C. in a drying cabinet and cooled in a desiccator. Subsequently, the sample, in a departure from DIN 53552, is charged to a quartz crucible (13 ml) and covered with a lid having a hole of approx. 2 mm in the middle. Finally, the crucible is heated to 950° C. in a muffle furnace for 7 min. The cooling is again effected in a desiccator. The volatile components are evident from the weight loss.

The sub-micron silicon particles, in crystalline or amorphous form, in the inventive composite may be surface-treated and may be in homogeneous distribution in a carbon body formed around these particles via intermediates produced by wet-chemical methods.

1. A process for producing a nanostructured silicon-carbon composite, the process comprising:
(A) introducing into a reactor components (A) comprising
(a1) a monohydroxyaromatic compound, a polyhydroxyaromatic compound, or both,
(a2) an aldehyde, and
(a3) a catalyst, to obtain a composition (A), in which
wherein the components (A) react with one another in the presence of the catalyst at a reaction temperature of 75 to 200° C., at a pressure of 80 to 2400 kPa, and over a duration t_{A} of 0.001 to 1 000 000 s, to obtain a pregel;
(B) introducing a component (B) comprising
(b1) a sub-micron silicon powder, which is crystalline or amorphous, into a composition obtained during or after the introducing (A), to obtain a product (B);
then
(C) introducing the product (B) into a neutralizing agent selected from the group consisting of
an acid if the catalyst (a3) is a basic catalyst, and
an alkali if the catalyst (a3) is an acidic catalyst to obtain a fine product (C);
(D) drying a product obtained during or after the introducing (C)₁ to obtain a product (D);
and then
(E) carbonizing the product (D) at a temperature of 500 to 1200° C. to obtain a silicon-carbon composite.

2. The process of claim 1, wherein the compound (a1) is at least one selected from the group consisting of a mono-hydroxybenzene, di-hydroxybenzene, and a trihydroxybenzene.

3. The process of claim 1, wherein the sub-micron silicon powder (b1) is introduced in an amount of 1 to 80% by weight based on a mass of the silicon-carbon composite.

4. The process of clam 1, wherein particles of the sub-micron powder (b1) have been surface-modified.

5. The process of claim 1, wherein the introducing (C) of the product (B) occurs by spraying or with vigorous stirring.

6. The process of claim 1, wherein the components (A) further comprise
(a4) a pore former selected from the group consisting of ethylene glycol, polyethylene glycol, butylene glycol, diethylene glycol, triethylene glycol, gamma-butyrolactone, propylene carbonate, dimethylformamide, monoethanolamine, N-methyl-2-pyrrolidinone, or a mixture of these substances.

7. The process of claim 1, wherein the silicon-carbon composite is granulated if said composite comprises particles having a mean size of less than 10 μm.

8. A nanostructured silicon-carbon composite obtained by the process of claim 1.

9. A nanostructured silicon-carbon composite having
a mean particle size of <40 μm,
a mesopore volume of 0.005 to 3 cm³/g,
a carbon content of 20 to 99% by weight, and
a proportion of the sub-micron silicon powder (b1) of 1 to 80% by weight.

10. An anode material, comprising the silicon-carbon composite of claim 8.

11. A lithium ion cell, comprising the silicon-carbon composite of claim 8.

12. A lithium ion battery, comprising the silicon-carbon composite of claim 8.

13. The nanostructured silicon-carbon composite of claim 8 having
a mean particle size of <40 μm,
a mesopore volume of 0.005 to 3 cm³/g,
a carbon content of 20 to 99% by weight, and
a proportion of the sub-micron powder (b1) of 1 to 80% by weight.

14. The process of claim 2, wherein particles of the sub-micron powder (b1) have been surface-modified.

15. The process of claim 2, wherein the introducing (C) of the product (B) occurs by spraying or with vigorous stirring.

16. The process of claim 2, wherein the silicon-carbon composite is granulated if said composite comprises particles having a mean size of less than 10 μm.

17. A nanostructured silicon-carbon composite obtained by the process of claim 2.

18. An energy storage system, comprising the anode material of claim 10.

19. An anode material, comprising the silicon-carbon composite of claim 17.

20. The nanostructured silicon-carbon composite of claim 17 having
a mean particle size of <40 μm,
a mesopore volume of 0.005 to 3 cm³/g,
a carbon content of 20 to 99% by weight, and
a proportion of the sub-micron powder (b1) of 1 to 80% by weight.
